(19) United States
(12) Patent Application Publication
(10) Pub. No.: US 2019/0291463 A1
(43) Pub. Date: Sep. 26, 2019

(54) PRINTING DEVICE

(71) Applicant: BROTHER KOGYO KABUSHIKI KAISHA, Nagoya-shi (JP)

(72) Inventor: Noriyuki KAWAMATA, Nagoya-shi (JP)

(21) Appl. No.: 16/220,676

(22) Filed: Dec. 14, 2018

(30) Foreign Application Priority Data
Mar. 20, 2018 (JP) 2018-051949

(51) Int. Cl. B41J 2/33; B41J 2/335; B41J 2/35

(52) U.S. Cl. CPC B41J 2/33; B41J 2/35; B41J 2/335

(57) ABSTRACT

A printing device includes a head holding part configured to hold a thermal head, a first roller configured to rotate while nipping the printing medium with the thermal head and thereby convey the printing medium, a second roller arranged on the downstream side with respect to the first roller convey the printing medium toward the downstream side, a first driving part configured to rotate the first roller in the first forward rotational direction, a second driving part configured to rotate the second roller in the second forward rotational direction, and a torque limiter provided to the second driving part. The torque limiter is configured to control transmission of a rotational driving force to the second roller.

### CROSS-REFERENCE TO RELATED APPLICATIONS

This application claims priority under 35 U.S.C. § 119 from Japanese Patent Application No. 2018-051949 filed on Mar. 20, 2018. The entire subject matter of the application is incorporated herein by reference.

### BACKGROUND

### Technical Field

The present disclosures relate to a printing device employing a thermal head for printing.

### Related Art

A printing apparatus provided with a sub roller arranged on a downstream side in a conveying direction of a printing medium relative to a thermal head and a main roller has been suggested. There has been known a tape printing device provided with a thermal head, a platen roller (which is an example of the main roller) and a feeding roller (which is an example of the sub roller). The printing device is configured such that laminated film and a print ribbon accommodated in a tape cassette are press-contacted onto a thermal head with a platen roller. In this state, as the thermal head selectively generates heat, letters, bar codes and the like are printed on the laminated film. The feeding roller is arranged on a downstream side, in a conveying direction of the laminated film, relative to the thermal head and the platen roller. The feeding roller presses both the laminated film, on which the letters or bar codes are printed, and a double-sided tape against a joining roller so that the double-sided tape is stuck on the laminated film, thereby a printed tape being created.

### SUMMARY

According to the above-described configuration of the printing device, the platen roller and the feeding roller may be rotated with use of a motor to covey the laminated film, which is a printing medium, to the downstream side. In such a case, a gripping force of the feeding roller relative to the printing medium may vary due to a configuration of the joining roller or the like provided to the tape cassette. Variation of the gripping force may cause variation of a conveying speed at a position where the printing medium contacts the thermal head, thereby causing deterioration of printing quality. If, however, the gripping force of the platen roller relative to the printing medium is increased in order to stabilize the conveying speed at the position where the printing medium contacts the thermal head, an excessive tension may act on the printing medium unfavorably.

According to aspects of the present disclosure, there is provided a printing device. The printing device includes a head holding part configured to hold a thermal head for printing on a printing medium, a first roller configured to rotate in a first forward rotational direction while nipping the printing medium with the thermal head and thereby convey the printing medium toward a downstream side in a conveying direction of the printing medium, a second roller arranged on the downstream side with respect to the first roller, the second roller being configured to rotate in a second forward rotational direction and thereby convey the printing medium toward the downstream side, a first driving part configured to rotate the first roller in the first forward rotational direction, a second driving part configured to rotate the second roller in the second forward rotational direction, and a torque limiter provided to the second driving part, the torque limiter being configured to control transmission of a rotational driving force to the second roller.

### BRIEF DESCRIPTION OF THE ACCOMPANYING DRAWINGS

FIG. 1 is a perspective view of a printing device in a state where a cassette is attached.

FIG. 2 is a front view of the cassette.

FIG. 3 is a perspective view of the printing device in a state where the cassette is not attached.

FIG. 4 is a front view of the printing device in a state where the cassette is attached.

FIG. 5 is an enlarged view of a part of FIG. 4.

FIG. 6 is a partial cross-sectional front view of the printing device shown in FIG. 1 at a line A-A and viewed from a direction indicated by arrows.

### DETAILED DESCRIPTION OF THE DRAWINGS

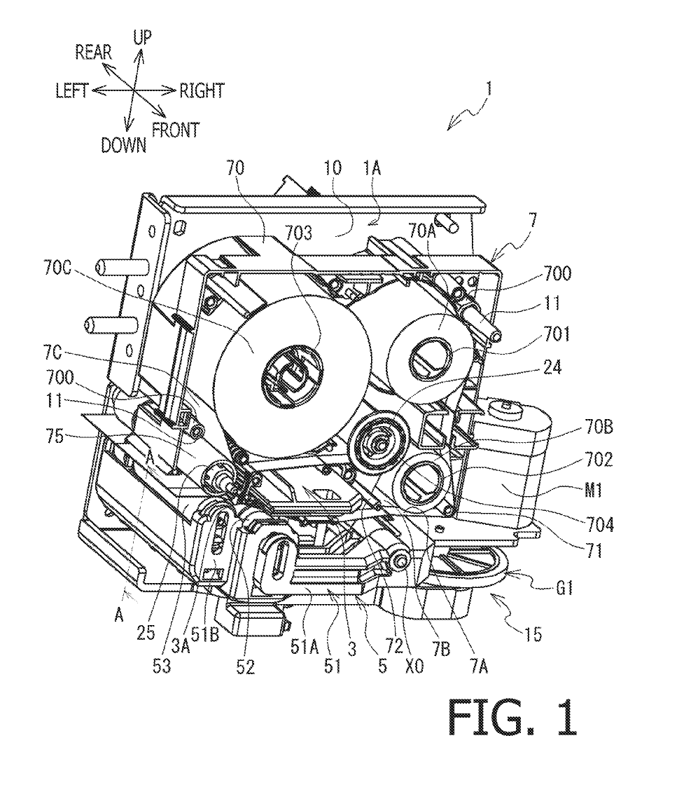

Hereinafter, referring to the accompanying drawings, a printing device 1, which is an embodiment according to the present disclosures will be described. In the following description, a lower right side, an upper left side, an upper right side, a lower left side, a left side and a right side in FIG. 1 will be defined as a front side, a rear side, an upside, a down side, a left side and a right side of the printing device 1, respectively.

<General Description of Printing Device 1>

The printing device 1 is a so-called a thermal transfer type thermal printer which is configured such that a thermal head 3A, which will be described later, applies heat to an ink ribbon 7B to transfer ink thereon to a printing medium 7A. The printing device 1 is further configured to create a label by sticking a tape part 7C on the printing medium 7A on which printing has been performed. As shown in FIG. 1, the printing device 1 is used with a cassette 7 being attached to an attachment part 1A. It is noted that a housing of the printing device 1 is omitted in FIGS. 1, 3 and 4. In the following description, directions of the printer 1 defined above are applied to describe directions of the cassette 7 attached to the printing device 7.

<Cassette 7>

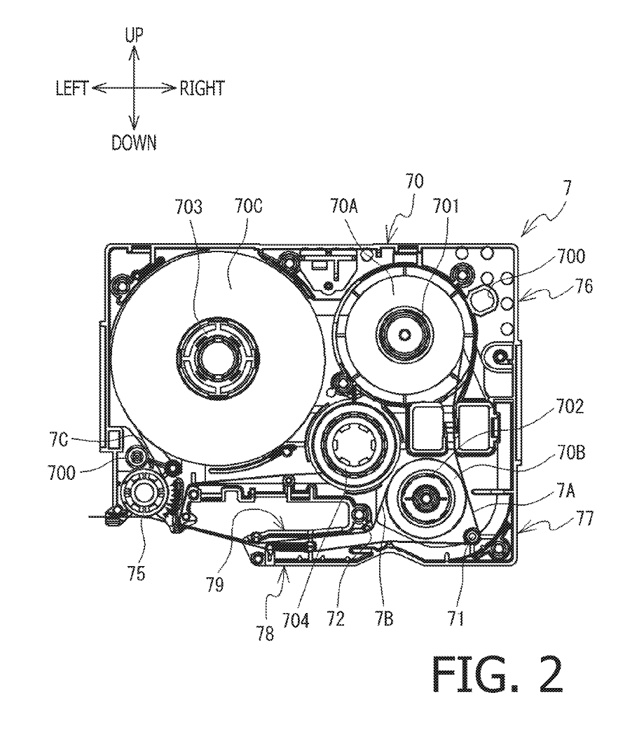

The cassette 7 has a housing 70 which has a box-like shape and is dividable into two parts in the front-rear direction. In FIG. 1, only a rear part of the housing 70 is shown, and a front part of the housing 70 is not shown. As shown in FIG. 2, the housing 70 has a main part 76, and protruding parts 77 and 78. The main part 76 has a substantially rectangular shape when viewed in the front-rear direction. The protruding part 77 protrudes downward from a right side with respect to a center, in the right-left direction, of a lower end portion of the main part 76. The protruding part 78 protrudes leftward from a left end portion of the protruding part 77. The lower end portion of the main part 76, the left end portion of the protruding part 77 and an upper end portion of the protruding part 78 define a head opening 79 penetrating the housing 70 in the front-rear direction.

The housing 70 accommodates therein the printing medium 7A, the ink ribbon 7B and the tape part 7C, each of which is wound in a roll. The printing medium 7A is wound around a core shaft 701 arranged on an upper side relative to a center in the up-down direction, and on a right side relative to a center in the right-left direction of the main part 76. The ink ribbon 7B is wound around a core shaft 702 arranged on the protruding part 77 at a position on a downer side relative to the core shaft 701. The tape part 7C is wound around a core shaft 703 arranged on an upper side relative to a center in the up-down direction and on a left side relative to a center in the right-left direction of the main part 76 of the housing 70. Each of the core shafts 701, 702 and 703 has a substantially cylindrical shape. A central axis of each of the core shafts 701, 702 and 703 extends in the front-rear direction. The core shafts 701 and 702 are arranged in the up-down direction, while the core shafts 701 and 703 are arranged in the right-left direction. In the following description, the rolled printing medium 7A, the rolled ink ribbon 7B and the rolled tape parts 7C will be referred to as a medium roll 70A, a ribbon roll 70B and a tape roll 70C, respectively.

A core shaft 704 is provided to the main part 76 at a position on an upper left side relative to the core shaft 702. The core shaft 704 is configured to take up a used portion of the ink ribbon 7B which has been delivered from the ribbon roll 70B and used for printing. The core shaft 704 has a substantially cylindrical shape. A central axis of the core shaft 704 extends in the front-rear direction. A sticking roller 75 is provided to a vicinity of a left end of a lower end portion of the main part 76. The sticking roller 75 has a substantially cylindrical shape, and is rotatably supported by the housing 70. A central axis of the sticking roller 75 extends in the front-rear direction.

The tape part 7C delivered from the tape roll 70C extends toward a lower right side from the tape roller 70C, contacts the sticking roller 75 and bends leftward. The tape part 7C further extends leftward from the sticking roller 75 and discharged from the cassette 7.

The printing medium 7A delivered from the medium roll 70A extends downward from the medium roll 70A, contacts a shaft part 71 provided to the protruding part 77 and bends leftward. The printing medium 7A extends leftward from the shaft part 71 passing through the protruding part 78. The printing medium 7A is discharged to outside from a left end portion of the protruding part 78, and passes through a lower side of the head opening 79. The printing medium 7A is supported by a portion of the main part 76 of the housing 70 close to the sticking roller 75, and contacts the tape part 7C which is in a state of contacting a lower end portion of the sticking roller 75. The printing medium 7A extends leftward with contacting and in parallel with the tape part 7C, and is discharged from the cassette 7 together with the tape part 7C.

The ink ribbon 7B delivered from the ribbon roll 70B extends toward a lower left side from the ribbon roll 70B, contacts a shaft part 72 provided to the protruding part 77 and is bent leftward. The ink ribbon 7B extends leftward from the shaft part 72 passing through the protruding part 78. The ink ribbon 7B is discharged outside from a left end portion of the protruding part 78, and passes through a lower part of the head opening 79. At this time, the ink ribbon 7B is arranged on an upper side relative to the printing medium 7A, and moves parallel to the printing medium 7A. The ink ribbon 7B bends at the vicinity of the sticking roller 75 of the main part 76, thereby being separated from the printing medium 7A. The ink ribbon 7B extends rightward passing through a vicinity of the lower end portion of the main part 76 to the core shaft 704.

Hereinafter, an extending direction of a portion of the printing medium 7A passing through a lower portion of the head opening 79 will be referred to as a “conveying direction of the printing medium 7A” or simply as a “conveying direction.” The conveying direction corresponds to the right-left direction of the printing device 1 and the cassette 7. Hereinafter, an “upstream side” and a “downstream side” will be defined with respect a moving direction of the printing medium 7A delivered from the medium roll 70A. Accordingly, in the printing device 1 and the cassette 7, the right side corresponds to the upstream side and the left side corresponds to the downstream side.

<Attachment Part 1A, Supporting Part 1B and Driving Part 15>

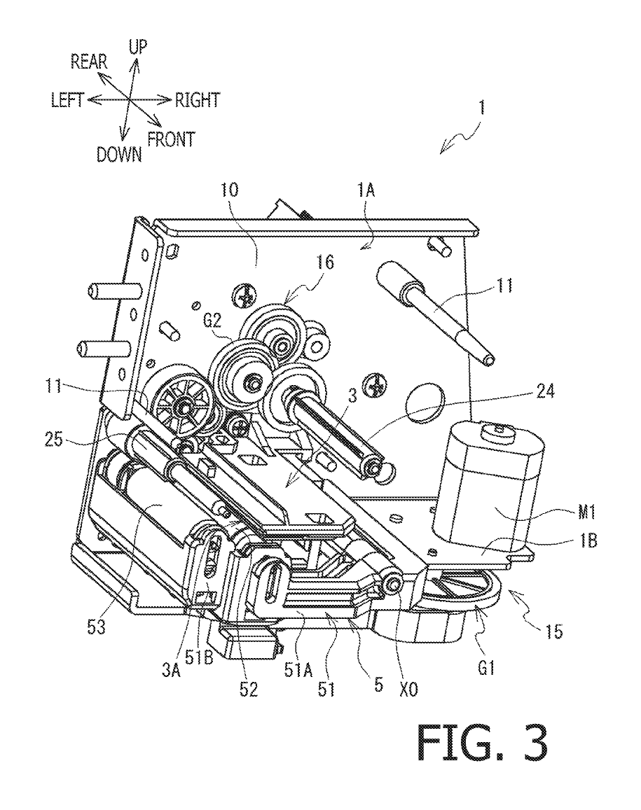

As shown in FIG. 1, the cassette 7 is detachably attached to the attachment part 1A. As shown in FIG. 3, the attachment part 1A has a plane part 10 which extends perpendicularly to the front-rear direction. There are multiple cylinders 11 extending frontward from the plane part 10, which are inserted in corresponding through holes 700 (see FIGS. 1 and 2) of the cassette 7 when the cassette 7 is attached to the attachment part 1A (see FIG. 1), thereby the cassette 7 being positioned relative to the printing device 1.

The supporting part 1B extends frontward from a lower end portion of the plane part 10 of the attachment part 1A. The supporting part 1B is plate-shaped, which extends perpendicularly to the up-down direction. The supporting part 1B supports a driving part 15 and a roller holder 5. The driving part 15 has a motor M1 supported on an upper surface of the supporting part 1B, and a plurality of gears G1 rotatably supported on a lower surface of the supporting part 1B. The driving part 15 is configured to transmit a driving force of the motor M1 to the roller holder 5 though the plurality of gears G1 to move the roller holder 5. The roller holder 5 will be described in detail later.

<Spools 24, 25 and Driving Part 16>

Substantially cylindrical spools 24 and 25 extend frontward from the plane part 10 of the attachment part 1A. As shown in FIG. 1, the spool 24 is inserted in the core shaft 704 when the cassette 7 is attached to the attachment part 1A. The spool 25 is inserted in the sticking roller 75 when the cassette 7 is attached to the attachment part 1A.

As shown in FIG. 3, a driving part 16 includes a plurality of gears G2 rotatably supported by the plane part 10, and a not-shown motor which is supported on a rear surface side of the attachment part 1A. The driving part 16 transmits a driving force of the not-shown motor to the spool 24 through the plurality of gears G2 to rotate the spool 24. As the spool 24 is driven to rotate by the driving part 16, the core shaft 704 shown in FIG. 1 rotates. The core shaft 704 makes the ink ribbon 7B be delivered from the ribbon roll 70B. The delivered ink ribbon 7B is taken up by the core shaft 704. The sticking roller 75, in association with a second roller 53 (described later), nips the printing medium 7A and the tape part 7C therebetween so that the printing medium 7A and the tape part 7C are stuck with each other. Further, the driving part 16 transmits the driving force of the not-shown motor to the first roller 52 through the plurality of gears G2 to rotate the first roller 52.

<Head Holding Part 3>

As shown in FIG. 3, a head holding part 3 extends frontward from the plane part 10 of the attachment part 1A. The head holding part 3 has a substantially plate shape, which extends perpendicularly to the up-down direction. The thermal head 3A is held on the lower surface of the head holding part 3. The thermal head 3A is a so-called line thermal head including multiple heating elements arranged in the front-rear direction. The printing device 1 performs a printing operation such that the thermal head applies heat to the ink ribbon 7B to transfer the ink thereon to the printing medium 7A.

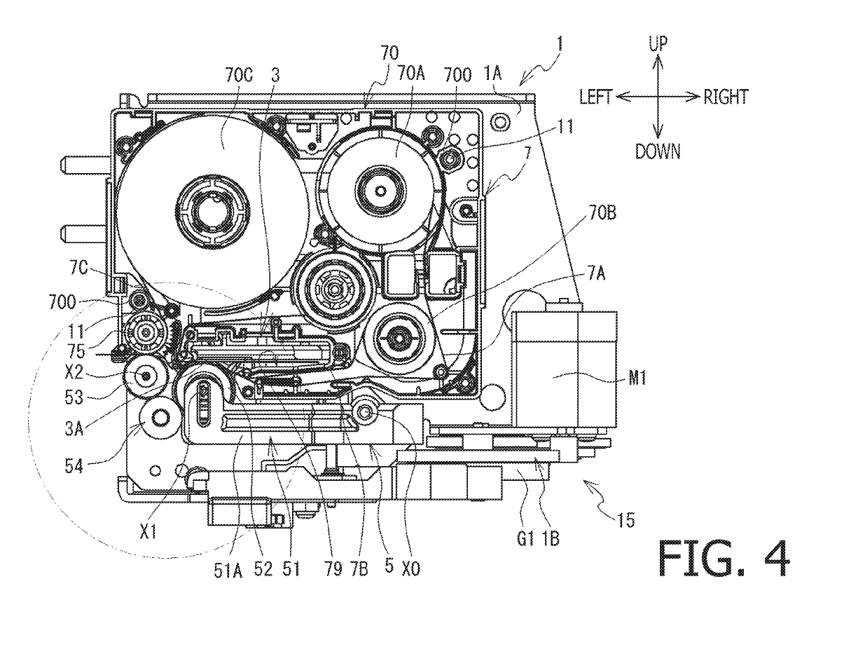

As shown in FIG. 4, in a state where the cassette 7 is attached to the attachment part 1A, the head holding part 3 is inserted in the head opening 79 of the cassette 7. In this state, the thermal head 3A is arranged on the upper side relative to the printing medium 7A and the ink ribbon 7B passing through the lower part of the head opening 79 in the right-left direction, and faces the ink ribbon 7B in the up-down direction.

<Roller Holder 5>

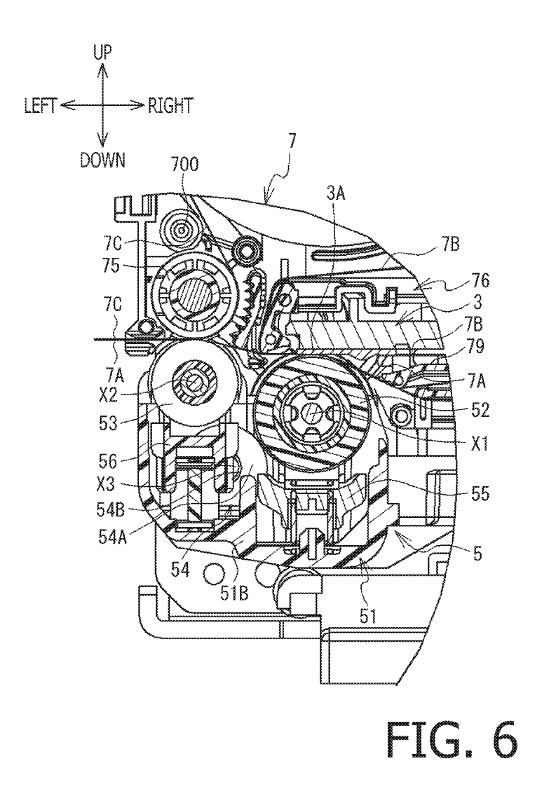

As shown in FIG. 3, the roller holder 5 is arranged on the lower side with respect to the head holding part 3. The roller holder 5 has a supporting part 51, a first roller 52, a second roller 53, a transmission part 54 (see FIG. 4), a first urging part 55 (see FIG. 6) and a second urging part 56 (see FIG. 6). The supporting part 51 has two arm parts 51A spaced in the front-rear direction, and an installation part 51B. One of the two arm parts 51A disposed on a rear side is not shown in FIG. 3. Each of the two arm parts 51A has a substantially stick-like shape extending in the right-left direction. Right end parts of the two arm parts 51A are rotatably supported by the supporting part 1B. The two arms 51A are rotatable about a rotation axis X0 extending in the front-rear direction. The installation part 51B is provided to bridge between the left end parts of the two arm parts 51A. The installation part 51B supports the first roller 52, the second roller 53, the transmission part 54, the first urging part 55 and the second urging part 56.

In a state where the cassette 7 is not attached to the attachment part 1A, the supporting part 51 rotates counterclockwise when viewed from the front side. In this case, the installation part 51B moves downward and is spaced from the head holding part 3. As shown in FIG. 4, when the cassette 7 is attached to the attachment part 1A, the supporting part 51 rotates clockwise when viewed from the front side. In such a case, the installation part 51B moves upward and approaches the head holding part 3. Hereinafter, a position of the supporting part 51 when the installation part 51B is spaced from the head holding part 3 (i.e., when the cassette 7 is not attached to the attachment part 1A) will be referred to as a “spaced position” and a position of the supporting part 51 when the installation part 51B is closely located to the head holding part 3 (i.e., when the cassette 7 is attached to the attachment part 1A) will be referred to as a “proximate position.”

As shown in FIG. 3, each of the first roller 52 and the second roller 53 has a cylindrical shape. The first roller 52 and the second roller 53 are supported by the installation part 51B such that each of the first roller 52 and the second roller 53 is rotatable and movable in the up-down direction relative to the installation part 51B. Each of a rotation axis X1 of the first roller 52 and a rotation axis X2 of the second roller 53 extends in the front-rear direction.

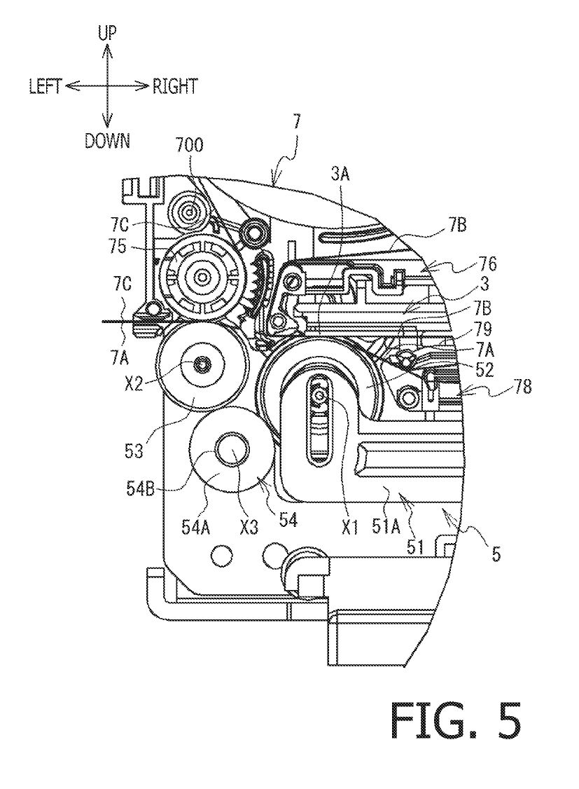

As shown in FIG. 5, when the supporting part 51 is located at the proximate position, the first roller 52 is arranged on the lower side relative to the thermal head 3A of the head holding part 3. In this case, in a state where the cassette 7 is attached to the attachment part 1A, the first roller 52 contacts the printing medium 7A from the lower side, and nips the printing medium 7A and the ink ribbon 7B between the first roller 52 and the thermal head 3A. When, for example, the first roller 52 rotates counterclockwise when viewed from the front side, the printing medium 7A and the ink ribbon 7B are conveyed to the downstream side. Hereinafter, the rotation direction of the first roller 52 to convey the printing medium 7A and the ink ribbon 7B to the downstream side will be referred to as a “first forward rotational direction.” Further, a rotation direction of the first roller 52 to convey the printing medium 7A and the ink ribbon 7B to the upstream side will be referred to as a “first reverse rotational direction.” It is noted that the first reverse rotational direction is a direction opposite to the first forward rotational direction (i.e., a clockwise direction of the first roller 52 when viewed from the front side).

In a state where the supporting part 51 is located at the proximate position, the second roller 53 is arranged on the downstream side relative to the first roller 52 and the head holding part 3, and on the lower side of the sticking roller 75 of the cassette 7 which is attached to the attachment part 1A. The second roller 53 and the sticking roller 75 face each other in the up-down direction. In this case, in a state where the cassette 7 is attached to the attachment part 1A, the second roller 53 contacts the printing medium 7A from the lower side, and the nips the printing medium 7A and the tape part 7C between the second roller 53 and the sticking roller 75. For example, when the second roller 53 rotates counterclockwise when viewed from the front side, the printing medium 7A and the tape part 7C are conveyed to the downstream side. Hereinafter, the rotation direction of the second roller 53 to convey the printing medium 7A and the ink tape part 7C to the downstream side will be referred to as a “second forward rotational direction.” Further, a rotation direction of the second roller 53 to convey the printing medium 7A and the tape part 7C to the upstream side will be referred to as a “second reverse rotational direction.” It is noted that the second reverse rotational direction is a direction opposite to the second forward rotational direction (i.e., a clockwise direction of the second roller 53 when viewed from the front side).

The transmission part 54 is arranged on an obliquely lower left side relative to the first roller 52 and an obliquely lower right side relative to the second roller 53. The transmission part 54 has a cylindrical body 54A and a torque limiter 54B. The cylindrical body 54A has a through hole extending in the front-rear direction along a central axis thereof. A shaft X3 extends in the front-rear direction and is inserted in the through hole of the cylindrical body 54A. The installation part 51B (see FIG. 3) supports right and left end portions of the shaft X3. The cylindrical body 54A is rotatable with respect to the shaft X3. A side surface (i.e., circumferential surface) of the cylindrical body 54A contacts each of side surfaces of the first roller 52 and the second roller 53.

The torque limiter 54B is configured to restrict transmission of a rotational driving force of the first roller 52, which is rotated by the driving part 16 (see FIG. 4), to the second roller 53 through the cylindrical body 54A. Specifically, in a state where the first roller 52 rotates in the first forward rotational direction, when load occurred in the second roller 53 is less than a particular amount, the torque limiter 54B connects the cylindrical body 54A and the shaft X3. Then, the rotational driving force of the first roller 52 which is rotating in the first forward rotational direction is transmitted to the second roller 53, and the second roller 53 rotates in the second forward rotational direction. In a state where the first roller 52 rotates in the first forward rotational direction, when the load of the second roller 53 is equal to or larger than the particular load, the torque limiter 54B disconnects the cylindrical body 54A from the shaft X3. Then, the rotational driving force of the first roller 52 is not transmitted to the second roller 53. When the first roller 52 rotates in the first reverse rotational direction, the torque limiter 54B separates the cylindrical body 54A from the shaft X3 regardless of a magnitude of the load. Accordingly, in this case, the rotational driving force of the first roller 52 is not transmitted to the second roller 53.

As shown in FIG. 6, the first urging part 55 is provided inside the installation part 51B and on the lower side with respect to the first roller 52. The first urging part 55 is configured to upwardly urge the first roller 52 toward the head holding part 3 arranged on an upper side relative to the first urging part 55. In a state where the cassette 7 is attached to the attachment part 1A, the first urging part 55 urges the printing medium 7A and the ink ribbon 7B toward the thermal head 3A (i.e., the printing medium 7A and the ink ribbon 7B are press-contacted with the thermal head 3A). The second urging part 56 is provided inside the installation part 51B and on a lower side with respect to the second roller 53. In a state where the cassette 7 is attached to the attachment part 1A, the second urging part 56 urges the second roller 53 toward the sticking roller 75 arranged on the upper side relative to the second roller 53. In this case the second urging member 56 urges the printing medium 7A and the tape part 7C toward the sticking roller 75 (i.e., the printing medium 7A and the tape part 7C are press-contacted with sticking roller 75).

<General Description of Printing Operation>

The cassette 7 is attached to the attachment part 1A of the printing device 1. In response to the rotational driving force of the motor M1 of the driving part 15 being transmitted through the plurality of gears G1, the supporting part 51 of the roller holder 5 moves from the spaced position to the proximate position. The first roller 52 is press-contacted toward the head holding part 3 by the first urging part 55. The first roller 52 nips, in association with the thermal head 3A, the printing medium 7A and the ink ribbon 7B. The second roller 53 is press-contacted toward the sticking roller 75 by the second urging part 56. The second roller 53 nips, in association with the sticking roller 75, the printing medium 7A and the tape part 7C.

In response to the rotational driving force of the not-shown motor of the driving part 16 being transmitted through the plurality of gears G2, the spool 24 rotates. As the core shaft 704, which is inserted in the spool 24, rotates, the ink ribbon 7B is delivered from the ribbon roll 70B of the core shaft 702 and moves to the downstream side in the conveying direction at the portion where the ink ribbon 7B and the printing medium 7A move in parallel. Further, in response to the rotational driving force of the not-shown motor of the driving part 16 being transmitted through the plurality of gears G2, the first roller 52 rotates in the first forward rotational direction. The first roller 52 conveys the printing medium 7A and the ink ribbon 7B to the downstream side. At the same time, the thermal head 3A of the head holding part 3 generates heat, thereby the ink ribbon 7B being heated. Then, the ink of the ink ribbon 7B is transferred onto the printing medium 7A. Accordingly, the printing operation has been performed. The used ink ribbon 7B is separated from the printing medium 7A and taken up by the core shaft 704.

The torque limiter MB of the transmission part 54 connects the cylindrical body 54A with the shaft X3 while the load occurred in the second roller 53 is less than the particular amount. The rotational driving force of the first roller 52 is transmitted to the second roller 53, and the second roller 53 rotates in the second forward rotational direction. It is noted that the sticking roller 75 and the second roller 53 nip the printing medium 7A on which the printing has been performed, and the tape part 7C therebetween, and stick the printing medium 7A and the tape part 7C to each other. Further, the sticking roller 75 and the second roller 53 convey the stuck printing medium 7A and tape part 7C to the downstream side.

When the load occurred in the second roller 53 becomes the particular amount or more, the torque limiter 54B of the transmission part 54 separates the cylindrical body 54A from the shaft X3. Then, transmission of the rotational driving force of the first roller 52 is restricted. In this case, a state of the second roller 53 is kept rotating in the second forward rotational direction at a torque smaller than a particular constant level. An operation of sticking the tape part 7C onto the printing medium 7A and conveying the same to the downstream side by the second roller 53 and the sticking roller 75 is continuously performed.

When the first roller 52 is rotated in the first reverse rotational direction by the driving part 16, the first roller 52 conveys the printing medium 7A and the ink ribbon 7B to the upstream side. Thus, when the first roller 52 rotates in the first reverse rotational direction, the torque limiter 54B of the transmission part 54 always separates the cylindrical body 54A from the shaft X3. The rotational driving force of the first roller 52 is not transmitted to the second roller 53, and the second roller 53 is in a state where the second roller 53 can freely rotate in the second reverse rotational direction. Thus, in response to movement of the printing medium 7A which is conveyed by the first roller 52, the second roller 53 rotates in the second reverse rotational direction. It is noted that movement of the printing medium 7A to the upstream side is not interrupted by the second roller 53.

<Effects of Present Embodiment>

The printing device 1 has the transmission part 54 configured to transmit the rotational driving force of the first roller 52 rotating in the first forward rotational direction to the second roller 53 so that the second roller 53 rotates in the second forward rotational direction. Therefore, the printing device 1 causes the driving part 16 to rotate the first roller 52 in the first forward rotational direction, and, at the same time, rotate the second roller 53 in the second forward rotational direction so that the printing medium 7A is conveyed to the downstream side with use of the first roller 52 and the second roller 53.

The printing device 1 further includes the torque limiter 54B provided to the transmission part 54. When the particular constant level or more torque is generated in the second roller 53 rotating in the second forward rotational direction, the torque limiter 54B is controlled such that transmission of the rotational driving force of the first roller 52 to the second roller 53 is restricted. Thus, according to the printing device 1, occurrence of the torque equal to or more than the particular constant level in the second roller 53 can be restricted. Accordingly, by restricting the printing medium 7A from being conveyed at an excessive speed by the second roller 53, the conveying speed at the position where the printing medium 7A contacts the thermal head 3A can be stabilized. Therefore, according to the printing device, the excellent printing quality can be maintained.

According to the printing device 1, there could be a case where the rotational speeds of the first roller 52 and the second roller 53 are adjusted in advance such that a conveying speed V2 of the second roller 53 for conveying the printing medium 7A is faster than a conveying speed V1 of the first roller 52 for conveying the printing medium 7A. The printing device 1 is configured as above since, if the conveying speed V1 is faster than the conveying speed V2, the printing medium 7A may slack between the first roller 52 and the second roller 53 and an appropriate printing process might be prevented. When the conveying speed V1 is faster than the conveying speed V2, if the second roller 53 generates a torque equal to or larger than a particular constant level, the conveying speed V1 may vary and excellent print quality may not be maintained. The printing device 1 is configured to suppress generation of the torque equal to or larger than the particular constant level in the second roller 53, thereby allowing the second roller 53 to rotate idly. According to the above configuration, since the variation of the conveying speed V1 can be prevented, the printing device 1 can maintain the excellent printing quality.

The printing device 1 is configured such that the tape part 7C is stuck onto the printing medium 7A, on which printing has been executed by the thermal head 3A, with use of the second roller 53 and the sticking roller 75. In accordance with a variation of the a force with which the printing medium 7A and the tape part 7C are press contacted, by the second roller 53, to the sticking roller 75, the torque acting on the second roller 53 may also be varied. As an example of such a variant of the torque, there is a case where different cassettes 7 respectively accommodating the printing media having different thicknesses are attached to the attachment part 1A. Even in such a case, the printing device 1 is capable of suppressing the torque acting on the second roller 53 from being equal to or larger than the particular constant level with use of the torque limiter 54B. Accordingly, the printing device 1 can stabilize the conveying speed at a position where the printing medium 7A contacts the thermal head 3A.

The first urging part 55 of the printing device 1 is configured to urge the first roller 52 toward the head holding part 3. According to this configuration, since the printing device 1 can press-contact the thermal head 3A to the printing medium 7A appropriately, the excellent printing quality can be maintained. Further, since the printing device 1 is configured such that the torque acting on the first roller 52 can be increased, the conveying speed at a position where the printing medium 7A contacts the thermal head 3A can be stabilized. Further, the second urging part 56 of the printing device 1 is configured to urge the second roller toward the sticking roller 75. Accordingly, the printing device 1 can make the printing medium 7A and the tape part 7C stick to each other appropriately.

When the first roller 52 rotates in the first reverse rotational direction, the torque limiter 54B of the transmission part 54 always separates the shaft X3 from the cylindrical body 54A. Accordingly, the rotational driving force of the first roller 52 is not transmitted to the second roller 53. The second roller 53 is idly rotatable in the second reverse rotational direction in accordance with movement of the printing medium 7A, which is conveyed to the upstream side by the first roller 52. Accordingly the above configuration of the printing device 1, in a state where the first roller 52 rotate in the first reverse rotational direction, it is suppressed that moving of the printing medium 7A to the upstream side is prevented by the second roller 53.

<Modifications>

Aspects of the present disclosures need not be limited to the above-described configuration of the illustrative embodiment, but further modifications can be available. According to the printing device 1, as the rotational driving force of the not-shown motor of the driving part 16 is transmitted to the plurality of gears G2, the first roller 52 rotates in the first forward rotational direction. Further, as the rotational driving force of the first roller 52 is transmitted to the second roller 53 through the transmission part 54, the second roller 53 rotates in the second forward rotational direction. The above configuration may be modified such that the printing device 1 may independently have a dedicated motor for driving the second roller 53. Further, the transmission part 54 may be arranged between the dedicated motor and the second roller 53. Furthermore, the rotational driving force of the dedicated motor may be transmitted through the transmission part 54 to the second roller 53, and the second roller 53 may rotate in the second forward rotational direction.

Alternatively, the transmission part 54 may be arranged between the motor M1 and the second roller 53. Then, it is configured such that, in response to the rotational driving force of the motor M1 being directly transmitted to the second roller 53 through the transmission part 54, the second roller 53 rotates in the second forward rotational direction.

The cassette 7 may be configured not to include the tape part 7C and the sticking roller 75. The printing medium 7A may be, after the ink of the ink ribbon 7B is conveyed as heated by the thermal head 3A, conveyed to the downstream side and discharged by the first roller 52 and the second roller 53. In such a case, at a portion, which faces the second roller 53, of the cassette 7 attached to the attachment part 1A, a supporting body configured to support the printing medium 7A from the above may be provided. That is, the second roller 53 may rotate with the printing medium 7A being sandwiched between the second roller 53 and the supporting body to convey the printing medium 7A. Further, the cassette 7 may be configured not to include the ink ribbon 7B. In such a case, the printing medium 7A may be a heat-sensitive paper which is configured to be color-developed as heated by the thermal head 3A.

According to the illustrative embodiment, the first urging part 55 is configured to urge the first roller 52 toward the head holding part 3 side. This configuration may be modified such that an additional urging part configured to urge the head holding part 3 toward the first roller 52 is provided. Alternatively, an urging part configured to urge the head holding part 3 toward the first roller 52, while the first urging part 55 may be omitted. Further alternatively, the printing device 1 may not be provided with the second urging part 56 configured to urge the second roller 53. In such a case, the cassette 7 may be provided with an urging part configured to urge the sticking roller 75 toward the second roller 53.

The torque limiter 54B may connect the cylindrical body 54A and the shaft X3 when the first roller 52 rotates in the first reverse rotational direction. In this case, in response to the rotational driving force of the first roller 52 being transmitted to the second roller 53, the second roller 53 may rotate in the second reverse rotational direction and convey the printing medium 7A to the upstream side.

The plurality of gears G2 is an example of a first driving part according to aspects of the present disclosures. The transmission part 54 is an example of a second driving part according to aspects of the present disclosures. The first urging part 55 is an example of an urging part according to aspects of the present disclosures. The tape part 7C is an example of a sticking medium according to aspects of the present disclosures.

What is claimed is:

1. A printing device comprising:
a head holding part configured to hold a thermal head for printing on a printing medium;
a first roller configured to rotate in a first forward rotational direction while nipping the printing medium with the thermal head and thereby convey the printing medium toward a downstream side in a conveying direction of the printing medium;
a second roller arranged on the downstream side with respect to the first roller, the second roller being configured to rotate in a second forward rotational direction and thereby convey the printing medium toward the downstream side;
a first driving part configured to rotate the first roller in the first forward rotational direction;
a second driving part configured to rotate the second roller in the second forward rotational direction; and
a torque limiter provided to the second driving part, the torque limiter being configured to restrict transmission of a rotational driving force to the second roller.

2. The printing device according to claim 1,
further comprising a motor,
wherein the first driving part is arranged between the motor and the first roller, the first driving part transmitting a rotational driving force of the motor to the first roller and thereby rotating the first roller in the first forward rotational direction,
wherein the second driving part is arranged between the first roller and the second roller, the second driving part transmitting a rotational driving force of the first roller, which is rotated in the first forward rotational direction by the first driving part, to the second roller and thereby rotating the second roller in the second forward rotational direction.

3. The printing device according to claim 1,
further comprising an attachment part to which a cassette is attached, the cassette including the printing medium, a sticking medium and a sticking roller for sticking the printing medium and the sticking medium to each other,
wherein the second roller:
faces the sticking roller of the cassette attached to the attachment part and sticks the printing medium and the sticking medium to each other by nipping the printing medium and the sticking medium in association with the sticking roller; and
conveys the stuck printing medium and sticking medium by a rotational movement.

4. The printing device according to claim 1, further comprising an urging part configured to urge one of the head holding part and the first roller toward an other of the head holding part and the first roller.

5. The printing device according to claim 2,
wherein the torque limiter allows the second roller to be driven to rotate in a second reverse rotational direction opposite to the second forward rotational direction when the first roller rotates in a first reverse rotational direction opposite to the first forward rotational direction.

6. A printing device comprising:
a thermal head configured to print on a printing medium;
a first roller arranged to nip the printing medium with the thermal head;
a first driving part configured to transmit a first rotational driving force to the first roller, the first roller rotating in a first forward rotational direction in response to the first rotational driving force, the first roller conveying the printing medium toward a downstream side in a conveying direction as the first roller rotates in the first forward rotational direction;
a second roller arranged on the downstream side relative to the first roller;
a second driving part configured to transmit a second rotational driving force to the second roller, the second roller rotating in a second forward rotational direction in response to the second rotational driving force, the second roller conveying the printing medium toward the downstream side as the second roller rotates in the second forward rotational direction; and
a torque limiter provided to the second driving part, the torque limiter being configured to restrict transmission of the second rotational driving force to the second roller.
